(19) United States
(12) Patent Application Publication
(10) Pub. No.: US 2007/0234400 A1
(43) Pub. Date: Oct. 4, 2007

(54) Information processing apparatus, processing apparatus, computer program product, and recording medium

(76) Inventor: Hideki Yanagi, Ibaraki (JP)

Correspondence Address: DICKSTEIN SHAPIRO LLP, 1825 EYE STREET NW, Washington, DC, 20006-5403, US

(21) Appl. No.: 11/715,887

(22) Filed: Mar. 9, 2007

(30) Foreign Application Priority Data
Mar. 20, 2006 (JP) 2006-077075

(51) Int. Cl. H04L 9/00

(52) U.S. Cl. 726/1

(57) ABSTRACT

A terminal device outputs a request to a printing apparatus to perform printing; controls a user interface so as to receive setting data required for execution of-the printing at the printing apparatus; transmits authentication information required for performing an authentication process at the printing apparatus to the external device. The authentication information is transmitted before activation of the user interface. The terminal device receives authorization information from the printing apparatus, refers to the authorization information and activates the user interface so that the user interface receives setting data required for realizing the printing at the printing apparatus.

### CROSS-REFERENCE TO RELATED APPLICATIONS

The present document incorporates by reference the entire contents of Japanese priority document, 2006-077075 filed in Japan on Mar. 20, 2006.

### BACKGROUND OF THE INVENTION

1. Field of the Invention

The present invention relates to an information processing apparatus that requests an external apparatus to perform a process, a processing apparatus that performs a process based on the details of the process received from such an information processing apparatus, a program that causes a computer to function as such an information processing apparatus, and a computer-readable recording medium having recorded thereon such a program.

2. Description of the Related Art

In recent years, people are really concerned about data security. For example, in processing apparatuses including image processing apparatuses, such as printers, that perform some process in response to a request from an external apparatus, there is a desire to limit users allowed to use the processing apparatus, limit functions used by each of the users, and the like.

To satisfy such a desire, some processing apparatuses are configured to determine, when they receive a request from an external apparatus, whether the user identified from the request is allowed to use the processing apparatus or allowed to use certain function of the processing apparatus.

For example, Japanese Patent Application Laid-Open No. 2005-065053 discloses a system in which a job transmitting apparatus, which is an external apparatus, receives input of an account name and a password from a user and transmits the account name and the password to an image forming apparatus, which is a processing apparatus. The image forming apparatus authenticates the job transmission source based on the received account name and password, and if the job transmission source is authentic, accepts a job and data related to the job from the transmitting apparatus.

On the other hand, Japanese Patent Application Laid-Open No. 2001-331286 discloses a printing system in which, a printer receives data such as print attributes from a computer, stores the received data in a database, use the data in the database to print a job. The data in the database can be changed through an operation of the computer before printing the job.

However, in the system disclosed in Japanese Patent Application Laid-Open No. 2005-065053, the job transmitting apparatus requests the image forming apparatus for authentication after accepting from the user the settings of parameters and other regarding the job. Therefore, if acceptance of the job is rejected based on the authentication result, the user cannot cause the job to be executed even though the user has performed a setting operation, which goes to waste.

The same goes for the system disclosed in Japanese Patent Application Laid-Open No. 2001-331286 even with the setting being changeable later, as long as use authorization is determined after the setting operation is completed. Similarly, such a problem occurs when a processing apparatus other than the image forming apparatus is utilized.

### SUMMARY OF THE INVENTION

It is an object of the present invention to at least partially solve the problems in the conventional technology.

According to an aspect of the present invention, an information processing apparatus includes a process requesting unit that outputs a request to request an external device to perform a process; a user-interface controlling unit that controls a user interface so as to receive setting data required for execution of the process at the external device; an authentication requesting unit that transmits authentication information required for performing an authentication process at the external device to the external device, wherein the authentication requesting unit transmits the authentication information to the external device before the user interface controlling unit activates the user interface; and a result receiving unit that receives authorization information from the external device in response to the authentication information, wherein the user-interface controlling unit refers to the authorization information and activates the user interface so that the user interface receives setting data required for realizing a function allowed for use from among functions of the external device.

According to another aspect of the present invention, a processing apparatus that performs a process requested from an information processing apparatus includes an authentication unit that performs an authentication process by using authentication information received from the information processing apparatus; and an authorization information transmitting unit that returns, to the information processing apparatus, authorization information indicating a function allowed for the transmission source of the authentication information to use from among functions of the processing apparatus when the authenticating unit determines that the authentication information is valid.

According to still another aspect of the present invention, a computer program product that causes a computer to execute outputting a request to request an external device to perform a process; controlling a user interface so as to receive setting data required for execution of the process at the external device; transmitting authentication information required for performing an authentication process at the external device to the external device, wherein transmission of the authentication information to the external device is performed before the controlling activates the user interface; and receiving authorization information from the external device in response to the authentication information, wherein the controlling includes referring to the authorization information and activating the user interface so that the user interface receives setting data required for realizing a function allowed for use from among functions of the external device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a drawing of a hardware configuration of a terminal device, which is an information processing apparatus, according to an embodiment of the present invention;

FIG. 2 is a drawing of a hardware configuration of a printing apparatus, which is a processing apparatus, according to the embodiment;

FIG. 3 is a schematic of an image processing system that includes a plurality of the printing apparatuses and the terminal device;

FIG. 4 depicts functional configuration of the terminal device and the printing apparatus;

FIG. 5 is an example of contents of authorization information;

FIG. 6 is a flowchart of a process procedure performed by the terminal device and the printing apparatus in the system depicted in FIG. 4;

FIG. 7 is a flowchart of an identification information transmitting process depicted in FIG. 6;

FIG. 8 is a drawing of an example of an input accepting dialog;

FIG. 9 is a flowchart of another example of the identification information transmitting process;

FIG. 10 is a flowchart of an authorization information transmitting process depicted in FIG. 6;

FIG. 11 is a flowchart of a print setting accepting process depicted in FIG. 6;

FIG. 12 is a drawing of an example of a print setting accepting screen;

FIG. 13 is a drawing of another example of the print setting accepting screen;

FIG. 14 is a drawing of still another example of the print setting accepting screen; and

FIG. 15 is a flowchart of a print data transmitting process depicted in FIG. 6.

### DETAILED DESCRIPTION OF THE PREFERRED EMBODIMENTS

Exemplary embodiments of the present invention are specifically explained below while referring to the accompanying drawings.

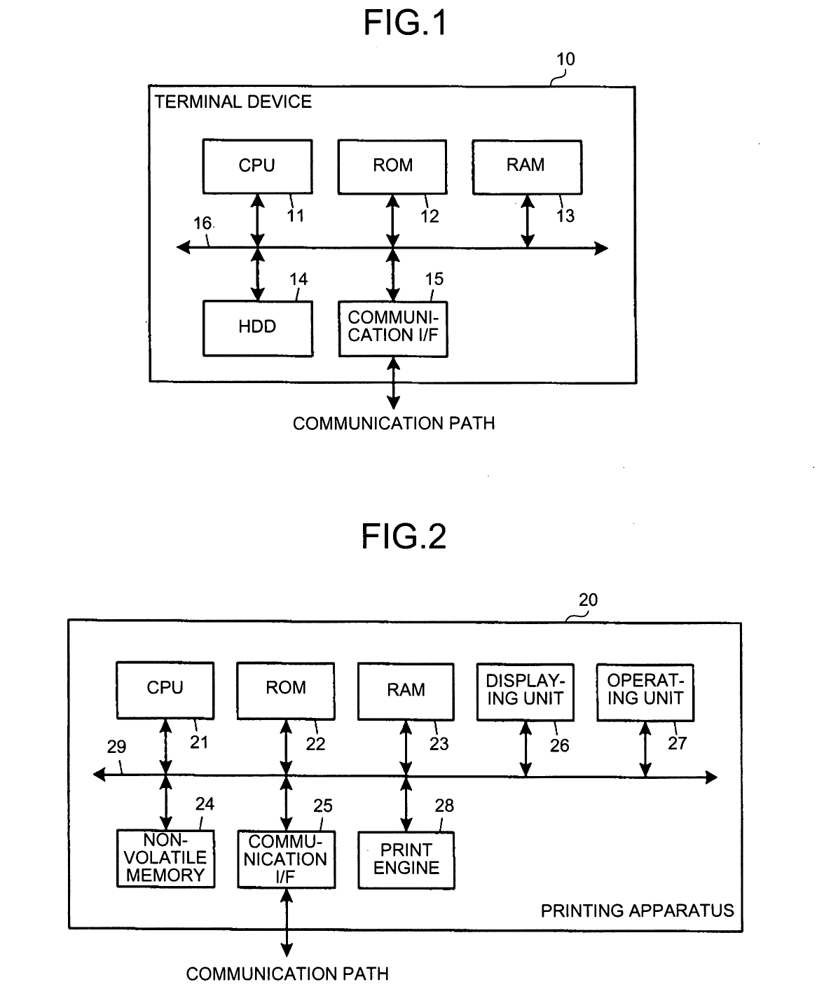

FIG. 1 depicts a hardware configuration of a terminal device 10, which is an information processing apparatus, according to an embodiment of the present invention. The terminal device 10 includes a central processing unit (CPU) 11, a read-only memory (ROM) 12, a random access memory (RAM) 13, a hard disk drive (HDD) 14, and a communication interface (I/F) 15. All these units are connected to each other through a system bus 16.

The CPU, 11 is a controlling unit that has centralized control over the entire terminal device 10. By executing various computer programs recorded on the ROM 12 and the HDD 14, the CPU 11 realizes various functions according to the features of the present embodiment. For example, when the CPU 11 executes a printer driver program recorded on the HDD 14 on an operating system, such as Windows (registered trademark), it is possible to achieve a function of requesting a printing apparatus to perform a printing operation.

The ROM 12 is a non-volatile storage unit, that stores therein computer programs to be executed by the CPU 11, parameters and data, and the like. The ROM 12 may be configured as a rewritable storage unit, thereby allowing these pieces of data to be updated.

The RAM 13 is a storage unit that stores therein data temporality for use or that is used as a work memory of the CPU 11.

The HDD 14 is a rewritable non-volatile storage unit, that stores therein computer programs to be executed by the CPU 11, values of parameters required to be retained even after the terminal device 10 is powered OFF, and the like.

The communication I/F 15 is an interface for connecting the terminal device 10 to a communication path, such as a network or a communication line, and can be taken as a network interface for, for example, Ethernet (registered trademark) communication. When communication is performed with another processing apparatus through a network, this communication I/F and the CPU 11 function as communicating units. The communication I/F 15 is configured such that it is suitable according to a network standard, a communication protocol for use, and others. Also, as a matter of course, a plurality of communication I/F 15 can be provided correspondingly to a plurality of standards.

The terminal device 10 is connected to a displaying unit (not shown), such as a display, and an input unit (not shown), such as a keyboard. The terminal device 10 causes the displaying unit to display process results, and receives input of instructions from users through the input unit.

The terminal device 10 can be a personal computer (PC).

FIG. 2 depicts a hardware configuration of a printing apparatus 20, which is a processing apparatus, according to the embodiment. The printing apparatus 20 includes a CPU 21, a ROM 22, a RAM 23, a non-volatile memory 24, a communication interface (I/F) 25, a displaying unit 26, an operating unit 27, and a print engine 28. These units are connected together through a system bus 29.

The CPU 21 is a controlling unit that has centralized control over the entire printing apparatus 20. The CPU 21 executes various computer programs recorded on the ROM 22 and the non-volatile memory 24 to realize various functions.

The ROM 22 and the RAM 23 are storage units similar to the ROM 12 and RAM 13 explained above. The non-volatile memory 24 is a rewritable non-volatile storage unit, such as a flash memory or an HDD, that stores computer programs to be executed by the CPU 21, values of parameters required to be retained even after the printing apparatus 20 is powered OFF, and others.

The communication I/F 25 is, as with the communication I/F 15, an interface for connecting the printing apparatus 20 to a communication path.

The displaying unit 26 includes a display, such as a liquid crystal display (LCD) or a light-emitting diode (LED), displaying, for example, an operation state and details of settings of the printing apparatus 20 or massages to users, according to the control of the CPU 21.

The operating unit 27 includes keys and buttons for accepting an operation by the user, allowing various settings regarding the operation of the printing apparatus 20 to be accepted.

The print engine 28 is an image forming unit that forms an image on a paper sheet according to image data received from an external device through the communication I/F 25 or read from the non-volatile memory 24. Arbitrary image forming scheme is adoptable, such as electrophotography, thermal transfer, dot impact, or ink jet.

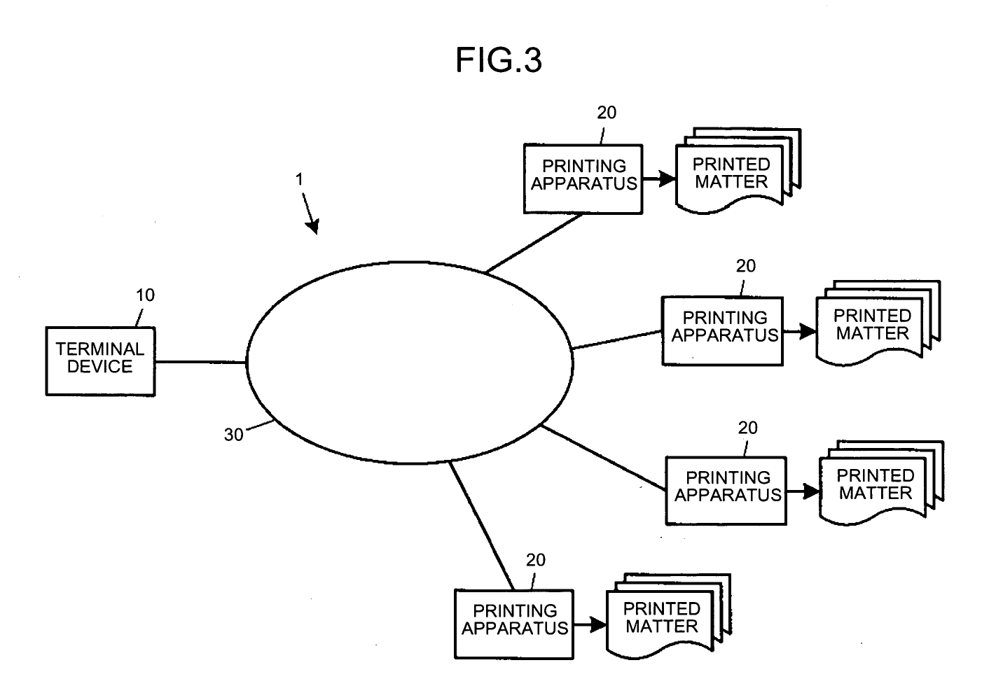

FIG. 3 is a schematic of an image processing system 1 that includes a plurality of the printing apparatus 20 and one terminal device 10.

In the image forming system 1, the terminal device 10 and the printing apparatuses 20 are connected through a communication path 30. The communication path 30 can be a network such as a local-area network (LAN). There can be a plurality of the terminal devices 10.

The terminal device 10 transmits a print request to any of printing apparatuses 20 that is desired to perform printing, thereby causing the printing apparatus 20 to perform printing. Upon receiving a print request, the printing apparatus 20 authenticates the user of the terminal device 10 from where the request has been received and also determines user's authority. If the printing apparatus 20 determines that the user is authentic and has the authority to use the function requested by the print request, it performs printing associated with the print request.

Upon receiving a request from the terminal device 10, the printing apparatus 20 authenticates the user of the terminal device 10 and also determines user's authority, and then informs the terminal device 10 of the results. Correspondingly, before accepting settings of the print details from the user, the terminal device 10 transmits authentication information, such as a user ID and a password, to the printing apparatus 20 to be requested for printing, thereby requesting authentication. In response to this, the terminal device 10 obtains from the printing apparatus 20 authorization information indicating a range of functions allowed for use, and then refers to this information to accept settings of the print details from the user within the range allowed for use.

What has been explained above is a feature of the present embodiment. In association with this, functions provided to the terminal device 10 and the printing apparatus 20 and processes performed on these devices are explained below.

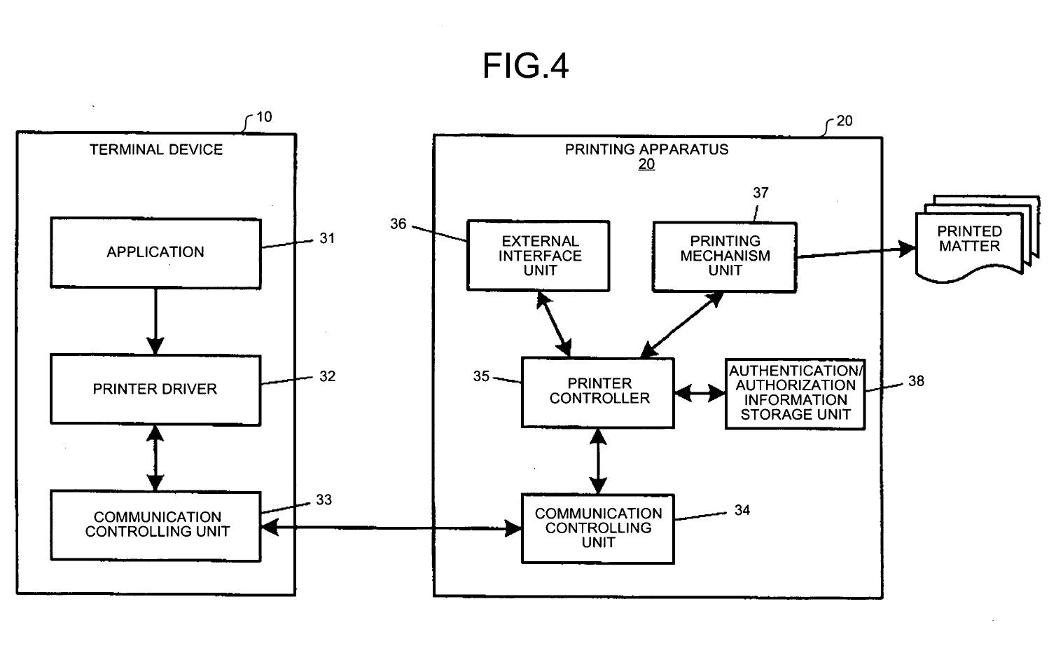

FIG. 4 depicts functional configuration of the terminal device 10 and the printing apparatus 20 for realizing the feature according to the embodiment. The terminal device 10 includes an application 31, a printer driver 32, and a communication controlling unit 33.

The application 31 represents a function achieved by causing the CPU 11 to execute any of various application programs, such as a word processor, spreadsheet, database, graphic rendering, image editing, and page editing. The application 31 has a function of generating data of documents, images, and others automatically or according to a user's instruction and, upon print instruction, passing to the printer driver 32 data of documents, images, and others to be printed.

The printer driver 32 represents a function achieved by causing the CPU 11 to execute a printer driver program. The printer driver 32 has a function of converting the data passed from the application 31 to print data in a format processable by the printing apparatus 20 and also transmitting a print request for requesting the printing apparatus 20 to perform a printing process based on the print data.

The printer driver 32 also has a function in which, when the user selects the printing apparatus 20 and desires the selected printing apparatus 20 to perform printing, it transmits authentication information for an authentication process to be performed by the printing apparatus 20, such as a user ID and a password representing user identification information, to the printing apparatus 20, thereby requesting authentication.

The printer driver 32 further has a function of controlling a user interface for accepting, from the user, settings of details of the printing process to be executed by the printing apparatus 20. The printer driver 32 still further has a function of referring to the authentication result and authorization information obtained as an response to the request for authentication to the printing apparatus 20 to activate user interface that accepts settings of a function allowed for the current user to use.

As the user interface, a graphical user interface (GUI) displayed on a display connected to the terminal device 10 is used. This is not meant to be restrictive and, for example, an operation panel using software keys or hardware keys may be used.

The communication controlling unit 33 has a function of controlling the communication I/F 15 for communication with an external device, thereby performing operations, such as transmitting authentication information and print data generated by the printer driver 32 to the printing apparatus 20 and receiving authorization information from the printing apparatus 20 for transfer to the printer driver 32.

On the other hand, the printing apparatus 20 includes a communication controlling unit 34, a printer controller 35, an external interface unit 36, a printing mechanism unit, and authentication/authorization information storage unit 38.

The communication controlling unit 34 has a function of controlling the communication I/F 25 for communication with an external device, thereby performing operations, such as receiving an authentication request or a print request from the terminal device 10 for transfer to the printer controller 35 and transmitting the authentication result and authorization information generated by the printer controller 35 to the terminal device.

The printer controller 35 has a function in which, when receiving a request from an external device, such as the terminal device 10, the printer controller 35 authenticates the request transmission source and, if the request transmission source has the authority to use the function associated with the request, controls other relevant components according to the request to cause the operation according to the request to be performed.

For example, if it is determined from the user ID and the password transmitted from the terminal device 10 that the user of the terminal device 10 has the authority to use a color printing function, the printing mechanism unit 37 is caused to perform printing according to the print request set with color printing. On the other hand, if it is determined that the user of the terminal device 10 does not have the authority to user the color printing function, execution of printing is rejected. At this time, the terminal device 10 is preferably notified as such. If the user of the terminal device 10 does not have the authority to use the color printing function but do have the authority to use a monochrome printing function, a function may be provided of automatically changing the request so as to be suited for the user's authority, such as automatically changing the color print setting to monochrome printing to cause the printing mechanism unit 37 to perform printing in association with the request.

The printer controller 35 also has a function in which, upon receiving an authentication request from an external device, the printer controller 35 compares the user ID and the password received together with the authentication request with a user ID and a password stored in the authentication/authorization information storage unit 38, and transmits, to the authentication request transmission source, authorization information indicating whether authentication has been successful and also a function allowed for the user of the transmission source to use. This authorization information can be written in extensible Markup Language (XML), which is a structured language, or can be generated as a list of commands allowed for execution.

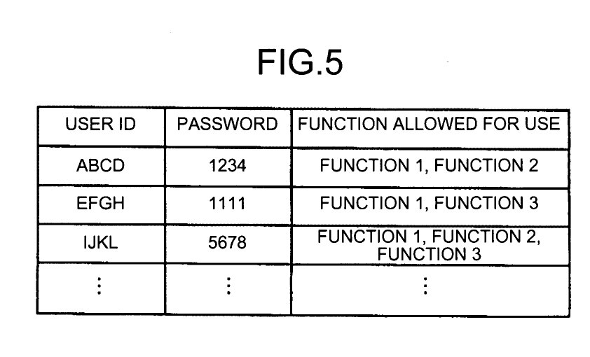

FIG. 5 depicts an example of contents of authorization information to be stored in the authentication/authorization information storage unit 38. The authentication/authorization information storage unit 38 stores therein an authorization information table. As depicted in FIG. 5 authorization information table stores therein, for each user allowed to use the printing apparatus 20, a user ID and a password of the user and a list of functions allowed for the user to use.

At authentication, if the user ID and the password received together with the authentication request match with a combination of the user ID and the password registered in the authorization information table, it is determined that the user is authentic and that the authentication request transmission source is allowed to use the functions corresponding to the user ID.

Here, “none” and “all functions” may be possible as settings of functions allowed for use. Also, the contents of the authorization information table can be changed upon an operation from the user having an administrator authority or upon a request from an external managing device, for example.

Returning to explanation of FIG. 4, the external interface unit 36 has a function of controlling the displaying unit 26 and the operating unit 27 to cause a message and others to be displayed and also to accept inputs from the user.

The printing mechanism unit 37 has a function of controlling the print engine 28 based on the image data to cause an image to be formed on a paper sheet. Also, when the image data is included in a print request from an external device, the printing mechanism unit 37 controls the operation of the print engine 28 based on the settings of the printing process included in the print request. This control can include selecting a paper sheet, performing post-processing, such as stapling, sorting, hole punching, and controlling a delivery position of the printed sheet and print density.

The authentication/authorization information storage unit 38 is a storage unit having stored therein the authorization information table as explained above.

The processes are explained below that are performed by the CPU in each of the terminal device 10 and the printing apparatus 20 and their operation sequence in association with execution of these process when the user operates the terminal device 10 to cause the printing apparatus 20 to perform desired printing.

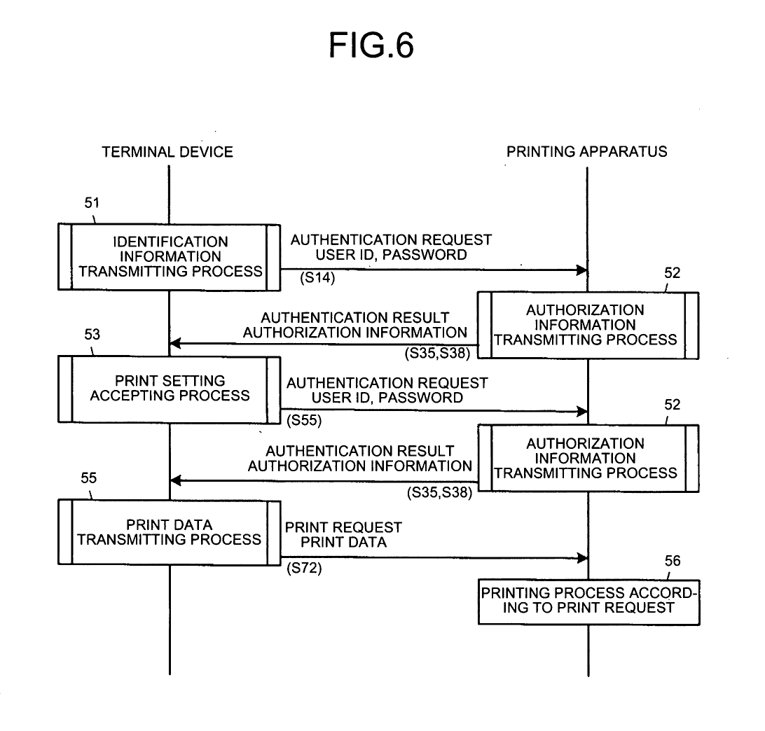

FIG. 6 is a drawing of an example of the operation sequence. An arrow drawn from a process block to a line of the counterpart represents that, in the source process, data above the arrow is transmitted and then received by the counterpart at a step with a step number in parentheses below the arrow. Also, among these process blocks, the ones with double lines on right and left will be explained in detail further below by using flowcharts.

The operation sequence of a series of operations depicted in FIG. 6 is started when a user selects printing at the terminal device 10.

First, the terminal device 10 (i.e., the CPU 11) performs an identification information transmitting process 51, transmitting an authentication request and also the user's user ID and password to the printing apparatus 20 selected by the user as an apparatus to be caused to perform printing.

Upon receiving the authentication request, the printing apparatus 20 (i.e., the CPU 21) performs an authorization information transmitting process 52, authenticating the user by using the received user ID and password and transmitting the authentication result and authorization information to the terminal device 10 as a response to the authentication request.

Upon receiving such information, the terminal device 10 performs a print setting accepting process 53 if authentication has been successful, causing a GUI for accepting print settings to be displayed on a display for accepting the settings of printing. At this time, by referring to the authorization information received from the printing apparatus 20, a GUI that accepts only the settings of functions allowed for use from among the functions of the printing apparatus 20 is displayed. In this process, when the user performs necessary settings and makes an instruction for performing printing, the terminal device 10 again transmits an authentication request as well as the user's user ID and password.

Upon receiving this authentication request, the printing apparatus 20 again performs the authorization information transmitting process 52, again authenticating the user by using the received user ID and password and transmitting the authentication result and authorization information to the terminal device 10 as a response to the authentication request.

Upon receiving such information, the terminal device performs a print data transmitting process 55 if determining that printing to be requested can be performed, generating a print request for instruction to perform printing according to the user's settings and print data indicating an image to be printed for transmission to the printing apparatus 20.

Upon receiving this print request, the printing apparatus 20 performs a printing process for printing an image indicated by the print data with the settings according to the print request (process 56). Although not depicted, as explained above, user authentication and authorization determination are also performed at this time.

The series of processes associated with printing now ends, and the printing apparatus 20 waits until receiving a new request. Similarly, the terminal device 10 waits until receiving a new instruction from the user after the print data transmitting process ends.

Next, the processes 51 to 55 are explained in more detail below by using flowcharts.

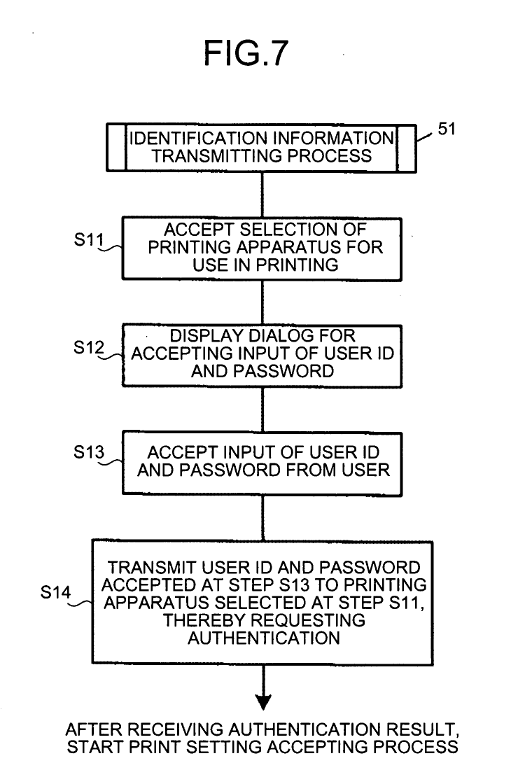

FIG. 7 is a flowchart of the identification information transmitting process 51. The CPU 11 of the terminal device 10 starts the process depicted in the flowchart of FIG. 7 when the user selects printing at the terminal device 10 by using the application 31.

First at step S11, through a GUI, such as a menu not depicted, specification of a printing apparatus for use in printing is accepted. At step S12, a dialog for accepting an input of a user ID and a password from the user is displayed on the display to prompt the user to enter. Then at step S13, by using the dialog, an input of the user ID and the password is accepted.

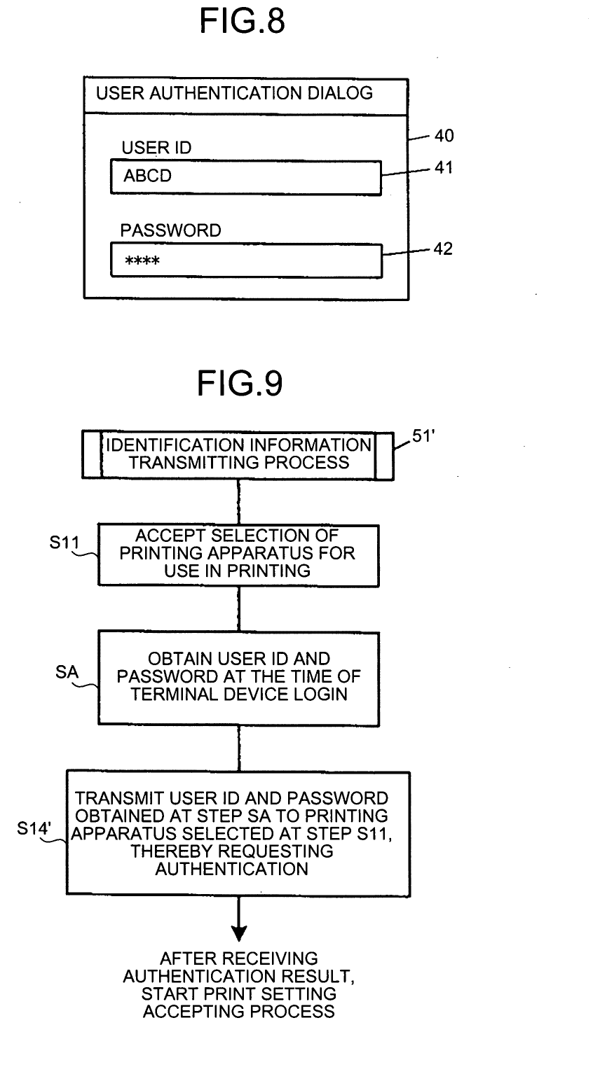

FIG. 8 is a drawing of an example of this dialog. An input accepting dialog 40 has a user ID input section 41 and a password input section 42. When the user enters the user ID and the password through a keyboard or the like in these sections and then presses an enter key, the procedure of FIG. 7 goes to step S14. Here, the password entered in the password input section 42 are displayed in a manner such that only representation indicating the number of characters is displayed with asterisks in order to prevent peeking from the others.

Returning to explanation of FIG. 7, at the next step S14, the user ID and password accepted at step S13 together with the authentication request are transmitted to the printing apparatus 20 selected at step S11, thereby requesting authentication. In this process at step S14, the CPU 11 functions as an authentication requesting unit.

Then, the terminal device 10 waits until receiving the authentication result (and authorization information) from the printing apparatus 20 and, upon receiving such result, the terminal device 10 starts the print setting accepting process 53.

Here, in place of the process depicted in FIG. 7, an identification information transmitting process 51′ depicted in FIG. 9 may be performed as an identification information transmitting process. That is, instead of prompting the user to enter the user ID and the password, the user ID and password used when the user logs in to the terminal device 10 may be obtained (SA), and then the obtained information may be transmitted to the printing apparatus 20 together with the authentication request. According to this approach, the user does not have to enter the user ID and the password every time the user selects a printing apparatus, thereby increasing operability.

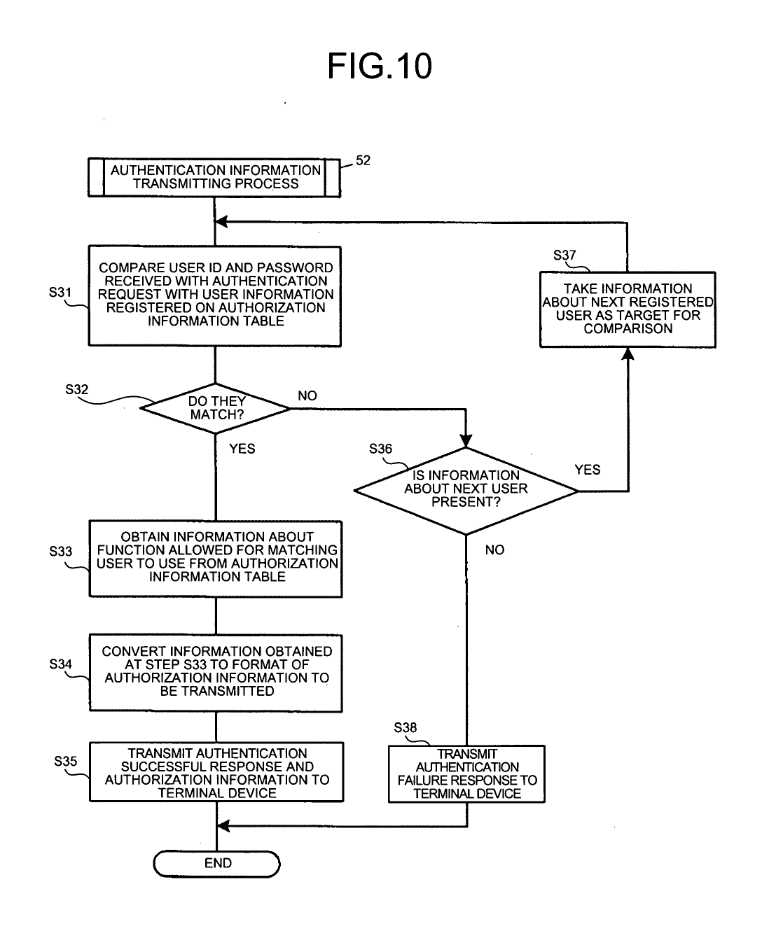

FIG. 10 is a flowchart of the authorization information transmitting process 52. When the printing apparatus 20 receives the authentication request from the terminal device 10, the CPU 21 of the printing apparatus 20 starts the process depicted in the flowchart of FIG. 10. First at step S31, the user ID and password received together with the authentication request are compared with the user ID and password registered on the authorization information table of the authentication/authorization information storage unit 38.

At step S32, it is determined whether these match. If they match, the system control is passed to step S33, where information about the functions determined as matching at step S32 and being allowed for the user to use is obtained from the authorization information table. At step S34, the information is converted to a format of authorization information to be transmitted to the terminal device 10. This conversion can be performed by, for example, converting the information to data in XML format, which is a format that can be interpreted by the terminal device 10, or converting the information to data representing a list of commands allowed for execution. The list of commands may be written in XML format. If the authorization information is written in the authorization information table in a format usable for transmission, no conversion is required.

At the next step S35, an authentication successful response indicating the authentication result and the authorization information obtained through conversion at step S34 are transmitted to the terminal device 10, and then the procedure ends.

On the other hand if they do not match at step S32, the system control is given to step S36, where it is determined whether user information to be compared next is registered in the authorization information table. If such user information is present, the system control is given to step S37 to return to step S31 with that user information to be compared, thereby repeating the process.

If it is determined as No at step S36, the combination of the received user ID and password is not registered in the authorization information table. Therefore, it is determined that the user of the terminal device 10 is not allowed to use the printing apparatus 20. At step S38, an authentication failure response indicating the authentication result is transmitted at step S38 to the terminal device 10, and then the procedure ends. In this case, a print setting accepting screen, which will be explained further below, is not displayed, or settings of printing are not accepted from the user.

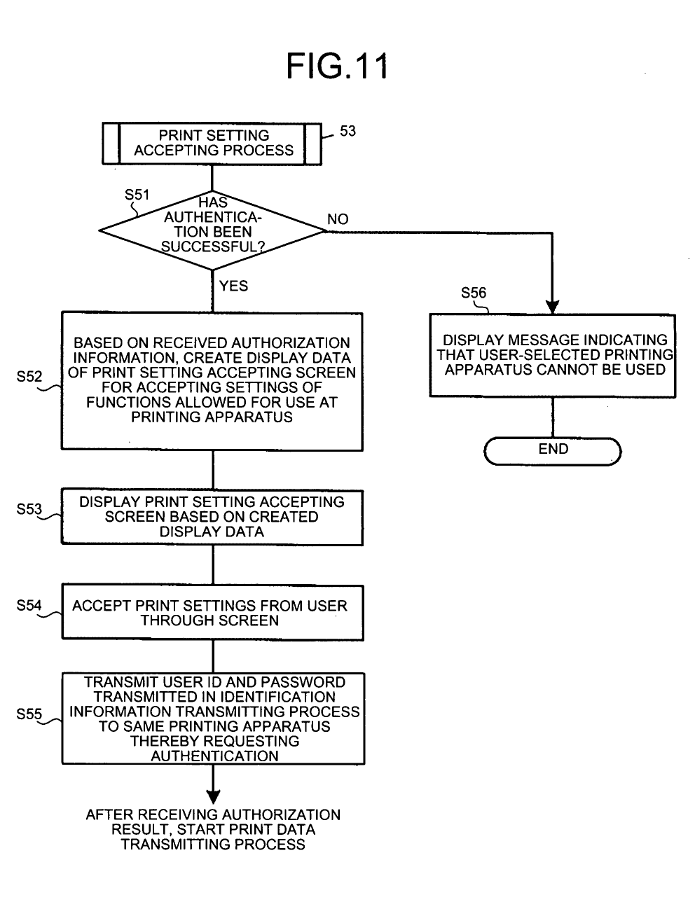

FIG. 11 is a flowchart of the print setting accepting process 53. Upon receiving the authentication result as a response to the authentication request transmitted at the identification information transmitting process 51, the CPU 11 of the terminal device 10 starts the process depicted in the flowchart of FIG. 11.

First at step S51, it is determined whether the authentication result indicates that authentication has been successful. If it has been successful, the authorization information as well as the authentication result is supposed to be received. The procedure then goes to step S52, where, based on the received authorization information, data of a print setting accepting screen for accepting settings of functions allowed for use at the printing apparatus 20 is created. Then at step S53, based on the generated display data, the print setting accepting screen is displayed on the display. Then at step S54, print settings are accepted from the user through the screen.

If the authorization information from the printing apparatus 20 is received in a form of a list of commands, such information is used later for generating a print request, and therefore information of these commands is retained. In the processes at steps S52 and S53, the CPU 11 functions as a user interface controlling unit.

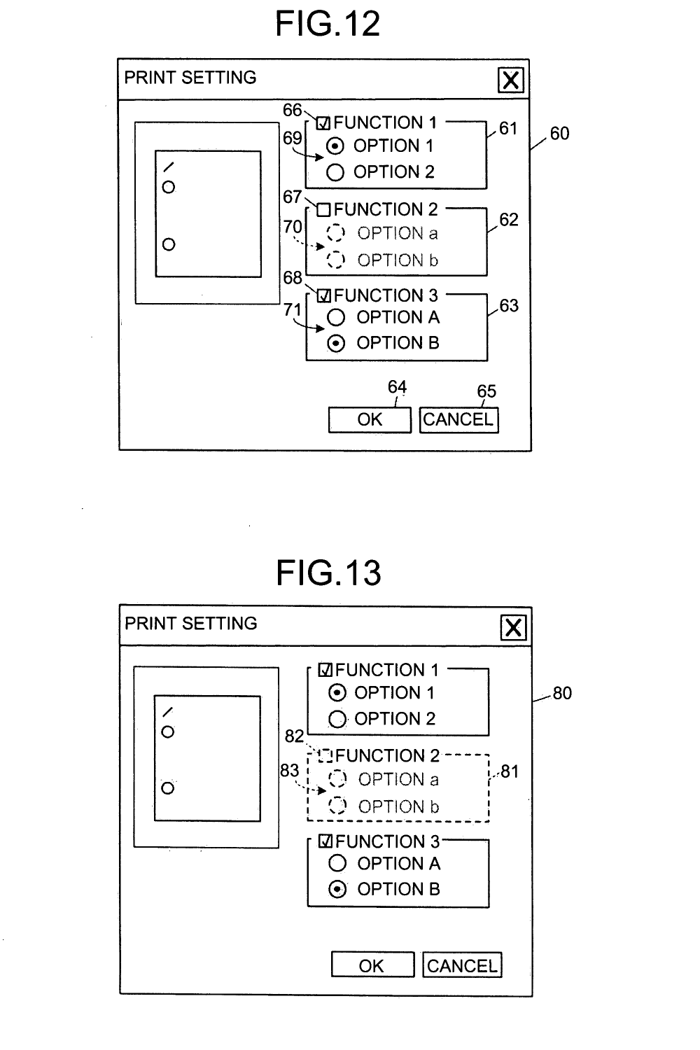

Also, the print setting accepting screen is, for example, as depicted in FIGS. 12 to 14. FIG. 12 is a drawing of an example of the screen when the user is allowed to use all functions. It is assumed herein that the printing apparatus 20 has three functions 1 to 3.

In this case, on a print setting accepting screen 60, for all of the functions 1 to 3, setting units 61 to 63 are provided, respectively, each for accepting a setting of the function. With check boxes 66 to 68 for the respective setting units, a setting of whether to use the relevant function is accepted. For a function to be used, radio buttons 69 to 71 are used to accept a more detailed optional setting.

In the example of FIG. 12, a setting is made in which the function 1 and the function 3 are to be used but the function 2 is not to be used. The radio buttons 70 for the function 2 not to be used gray out so as not to allow any operation. However, if the check box 67 is checked, the radio buttons 70 are changed to normal display, thereby allowing an optional setting of the function 2.

After the user makes necessary settings on this screen and then presses an OK button 64, the settings are regarded as completed, and the procedure depicted in FIG. 11 then goes to step S55. On the other hand, when the user presses a cancel button 65, the CPU 11 determines that printing has been canceled, and then suspends the process depicted in FIG. 11 for termination of the process.

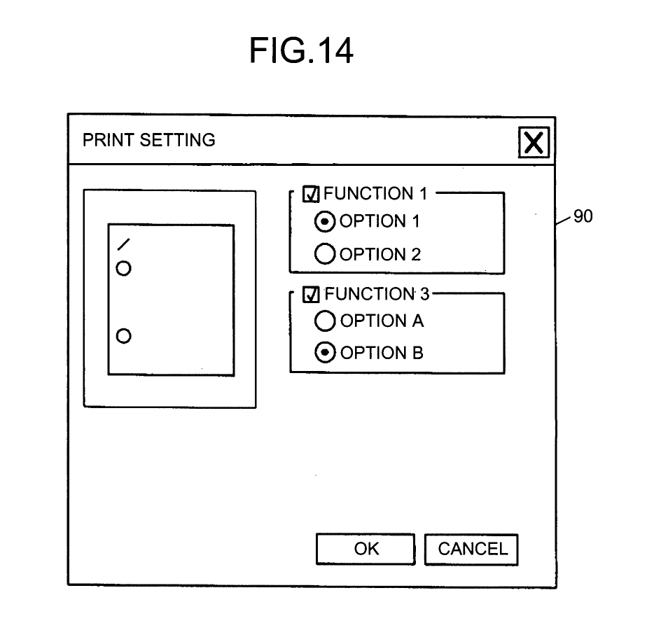

FIGS. 13 and 14 are drawings of screen examples when the user is allowed to use only the function 1 and the function 3 from among the functions 1 to 3 explained above.

In a print setting accepting screen 80 depicted in FIG. 13, the setting units corresponding to all functions are displayed, but the setting unit 81 regarding the function 2 not allowed for use grays out entirely and cannot be operated.

In a print setting accepting screen 90 depicted in FIG. 14, the setting unit regarding the function 2 not allowed for use is not displayed to begin with.

Therefore, in either case, the screen serves as a user interface in which only the portion that accepts settings of the functions allowed for use at the printing apparatus 20 is activated. As a matter of course, this holds true for the example depicted in FIG. 12. Also, in either case, the function of the OK button and the cancel button is similar to that in the case of the example depicted in FIG. 12.

Here, the data of the print setting accepting screen can be generated by processing the authorization information through an XML parser according to a predetermined fixed rule as long as the authorization information is written in XML format. For example, when the screen is displayed on a Hypertext Markup Language (HTML) browser, a tag representing an available function is replaced by an HTML tag indicating a setting unit and a check box, an also a tag indicating an available option is replaced by a tag representing a radio button. Then, the tags after replacement are embedded in data of an outer frame of the screen.

With this, even if a new function of the printing apparatus 20 is added or the existing functions thereof are changed, such addition or change can be handled without much changing the program for generating display data, and therefore the apparatus can be easily improved. If the authorization information in XML format includes information about commands corresponding to the respective functions and the terminal device 10 can refer to the information to generate a command associated with a print request, a correspondence between functions and commands does not have to be stored on the terminal device 10 side. Therefore, addition and change of a function can be easily handled.

Returning to explanation of FIG. 11, as explained above, when the user presses the OK button on the print setting accepting screen, the system control is given to step S55, where the user ID and password transmitted in the identification information transmitting process are transmitted to the same printing apparatus 20 as that in the identification information transmitting process, thereby again requesting authentication. Then, the terminal device 10 waits until receiving the authentication result (and authorization information) from the printing apparatus 20 and, upon receiving it, starts the print data transmitting process 55. Also at this step S55, the CPU 11 functions as an authentication requesting unit.

Here, authentication is again requested because of the following. That is, since it takes some time to accept print settings, the authorization information table of the printing apparatus 20 may be changed during that time and a function allowed for use at the time of the previous authentication may no longer be allowed for use. In such a case, even with a print request or generation and transmission of print data, printing is not allowed, thereby wasting process resources and communication bands. To get around this, it is preferable that authentication be again requested to check, even at the time of transmission, whether it is possible to cause the printing apparatus 20 to perform a printing operation to be requested.

On the other hand, if it is determined as No at step S51, the system control is given to step S56, where a message indicating that the printing apparatus selected by the user cannot be used is displayed on the displayed, and then the process ends. In this case, in consideration of an erroneous input of either or both of the user ID and the password, the procedure may return to step S12 of the identification information transmitting process 51 depicted in FIG. 7 for repeating the process.

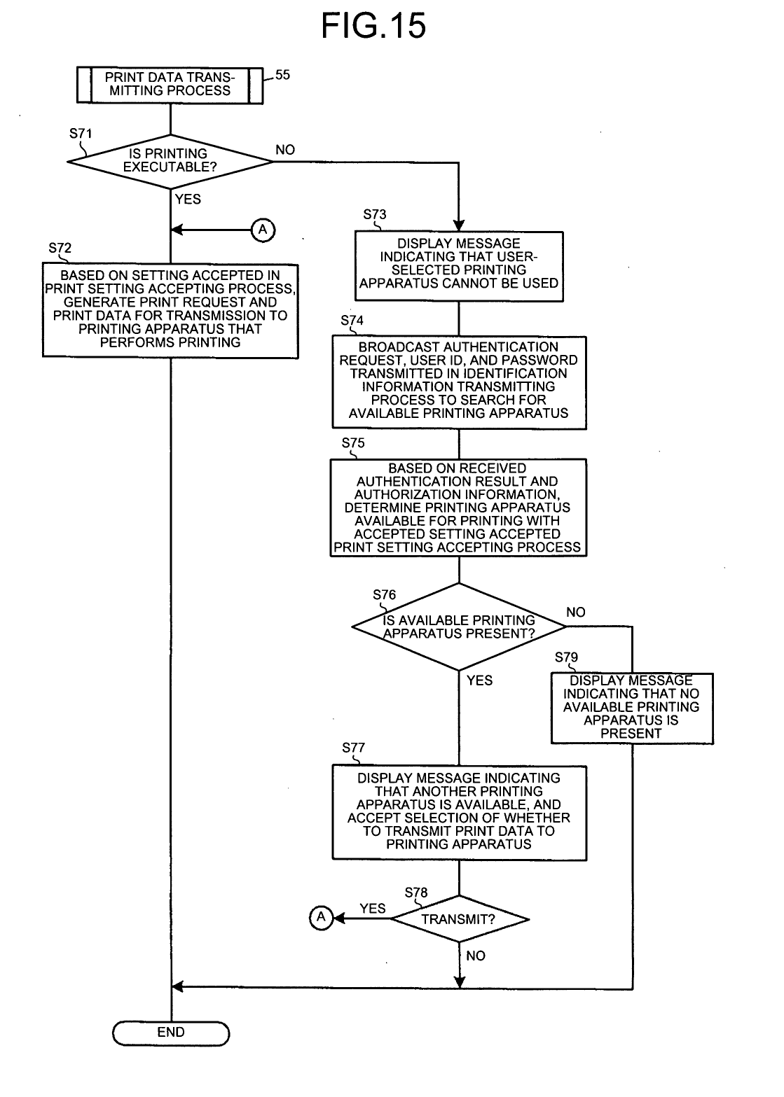

FIG. 15 is a flowchart of the print data transmitting process 55. The CPU 21 of the printing apparatus 20 also performs the authorization information transmitting process 52 even for the authentication request transmitted at step S55 of FIG. 11 from the terminal device 10, and transmits the authentication result. Therefore, upon receiving this authentication result, the CPU 11 of the terminal device 10 starts the flowchart of FIG. 15.

First at step S71, the received authentication result and authorization information are referred to, thereby determining whether it is possible to cause the printing apparatus 20 to perform printing with the settings accepted at step S54 of FIG. 11. In the process of FIG. 11, only the settings of the functions allowed for the user to use can be accepted. Therefore, the determination is supposed to be Yes unless the authorization information table is changed after authentication is requested at step S14 of FIG. 7 or 9.

If it is determined as Yes at step S71, the system control is given to step S72, where a print request and print data are generated based on the settings accepted in the print setting accepting process 53 for transmission to the printing apparatus 20 for printing, and then the procedure ends.

In this case, the printing apparatus 20 performs printing according to the print request, thereby allowing the user to obtain printed matter. Also, if the authorization information is received in a form of a list of commands from the printing apparatus 20, a command can be selected from the list to generate a print request.

Also, in the process at step S72, the CPU 11 functions as a process requesting unit.

On the other hand, if it is determined as No at step S71, the system control is given to step S73, where a message indicating that the printing apparatus selected by the user cannot be used. Then, although the process may end at this stage, the system control is given to step S74 in the present embodiment, where the authentication request and the user ID and password transmitted in the identification information transmitting process 51 are broadcasted to search for an available printing apparatus. At this time, a broadcasting range may be only within the same network segment, or may allow transmission over the segment. For transmission over the segment, it is preferable to cause the user to set in advance a range to which transmission is performed.

If an apparatus that can understand the authentication request is present within the broadcasting range, the apparatus is supposed to return the authentication result (and authorization information). Therefore, at step S75, based on the authentication result and the authorization information, a printing apparatus that can perform printing with the settings accepted in the print setting accepting process 53, that is, a printing apparatus available for that printing, is determined.

In these processes at steps S74 and S75, the CPU 11 functions as a searching unit.

Then-at step S76, it is determined whether an available printing apparatus is present. If such an apparatus is present, the system control is given to step S77, where a message indicating that another printing apparatus is available is displayed on the display, thereby accepting selection of whether to transmit print data to that printing apparatus. At this time, the name and address of the available printing apparatus are preferably displayed. If a plurality of printing apparatuses are available, a printing apparatus to which print data is to be transmitted can also be selected.

Upon selection by the user, the system control is given to step S78. If transmission is to be performed, the system control is given to step S72, where a print request and print data are transmitted to the printing apparatus to be caused to perform printing. In this case, the print-requested destination is changed to the printing apparatus found by search. If transmission is not to be performed, the process directly ends.

Also, if no available printing apparatus is present at step S76, a message indicating that no available printing apparatus is present is displayed at step S79, and then the process ends.

Here, whether to perform processing at step S74 and onward can be set by the user.

Thus, when the user uses the printing apparatus 20 for printing, the user inquires in advance of the printing apparatus 20 about the functions allowed for the user to use. For functions not allowed for use, no setting is accepted from the user. Therefore, such a situation can be prevented that the user makes settings of functions not allowed to use and execution of printing is rejected by the printing apparatus 20, thereby resulting in a waste of the setting operation performed.

Also, when the use of the printing apparatus 20 itself is not allowed, the user can recognize as such before performing a setting operation. Therefore, such a situation can be prevented that the setting operation goes to waste. Furthermore, in this case, the user is notified as such. Therefore, the user can quickly recognize that the use of the printing apparatus desired to be used is not allowed for use.

Still further, when the use of the printing apparatus selected by the user is not allowed for use after the settings of the printing are accepted, a search is made for another available printing apparatus. Therefore, an apparatus capable of performing printing desired by the user can be searched for, thereby possibly preventing the settings made by the user from going to waste.

Still further, in the printing apparatus 20, the process according to the authentication request and the process according to the print request are separated from each other. Therefore, even a terminal device transmitting a print request without obtaining authorization information in advance can be handled.

In the foregoing, the embodiments have been explained. As a matter of course, the configuration of the information for use, the contents of the display screen, specific processes, and others are not meant to be restricted to those explained in the embodiments explained above.

For example, in the embodiments explained above, searching the printing apparatus is performed when it is determined as No at step S71 of FIG. 15. Alternatively, even when it is determined as No at step S51 of FIG. 11, similar searching can be performed. In this case, since no print setting has been accepted, whether printing is made is determined according to whether authentication is successful. Also, when it is determined as Yes at step S78, the system control is given to step S52 of FIG. 11, and then at step S55, an authentication request and others are transmitted to the apparatus selected at step S77.

Also, the authentication request at step S55 of FIG. 11 may be omitted, and the procedure may goes directly to step S72 of FIG. 15 immediately after step S54. In this case, if printing is rejected by the printing apparatus 20, the procedure may go to step S73.

Furthermore, as the authentication information for use in authentication, information other than the user ID and the password can be used. For example, an ID issued not for each user but for each section or group may be used, or public key certificate may be used.

Still further, on the authorization information table, the functions allowed for use can be specified not only in units of “function” on the print setting accepting screen as depicted in FIG. 12, but also in units of “option”, and the print setting accepting screen can be displayed accordingly so as to reflect as such.

Still further, as a matter of course, the present invention can be applied not restrictively to an image processing apparatus, such as a printing apparatus, and a terminal device for instructing the printing apparatus for printing, but also to an arbitrary processing apparatus performing a process requested from an external device and an arbitrary information processing apparatus requesting such a processing apparatus to perform a process. Examples of the processing apparatus to which the present invention can be applied are network electrical appliance; vending machines; medical equipment; power supply units; air-conditioning systems; meter systems for gas, water, electricity, and others; general-purpose computers, automobiles, airplanes, and others. Also, examples of the information processing apparatus are, in addition to general-purpose computers, portable information terminals, cellular phones, and others.

Still further, a computer program according to another embodiment of the present invention causes a computer to function as the information processing apparatus, such as the terminal device 10. With such a computer program being executed by the computer, effects as explained above can be achieved.

Such a computer program may be stored in advance in a storage unit, such as a ROM or an HDD, incorporated in the computer and can also be provided as being recorded on a compact disk read-only memory (CD-ROM), which is a recording medium, or a non-volatile recording medium (memory), such as a flexible disk, a static random access memory (SRAM), an electrically erasable programmable ROM (EEPROM), or a memory card. With the computer program recorded on the memory being installed in the computer for execution by the CPU or the program being read by the CPU from the memory, each procedure explained above can be performed.

Still further, the computer program can be downloaded for execution from an external device connected to a network and including a recording medium having recorded thereon the program or from an external device having the program stored in its storage unit.

Also, the embodiments and modification examples explained above can be applied in combination as appropriate within a non-contradictory range.

According to the information processing apparatus and processing apparatus of exemplary embodiments as explained in the forgoing, when the information processing apparatus is operated to request another apparatus for authentication at the time of use and to perform an operation, the setting operation performed can be prevented from going to waste, and operability can be increased.

Also, according to the computer program of the embodiment, a computer is made to function as an information processing apparatus to achieve the functions as explained above, thereby obtaining similar effects.

According to the recording medium of the embodiment, a computer that does not have stored therein the program explained above is caused to read the program for execution, thereby obtaining similar effects as above.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a process requesting unit that outputs a request to request an external device to perform a process;
a user-interface controlling unit that controls a user interface so as to receive setting data required for execution of the process at the external device;
an authentication requesting unit that transmits authentication information required for performing an authentication process at the external device to the external device, wherein the authentication requesting unit transmits the authentication information to the external device before the user interface controlling unit activates the user interface; and
a result receiving unit that receives authorization information from the external device in response to the authentication information, wherein
the user-interface controlling unit refers to the authorization information and activates the user interface so that the user interface receives setting data required for realizing a function allowed for use from among functions of the external device.

2. The information processing apparatus according to claim 1, wherein
the authentication requesting unit transmits the authentication information to the external device even before the process requesting unit requests the external device to perform the process,
the authorization information includes authentication result information that indicates whether authentication is successful, and
the process requesting unit outputs the request to the external device when the authentication result information indicates that the authentication is successful.

3. The information processing apparatus according to claim 1, the authorization information includes use-allowed information that, indicates whether the user is allowed to use the external device,
the information processing apparatus further comprising a notifying unit that notifies a user that the external device is not allowed to be used when the use-allowed information indicates that the user is not allowed to use the external device.

4. The information processing apparatus according to claim 1, the authorization information includes use-allowed information that indicates whether the user is allowed to use the external device,
the information processing apparatus further comprising:
a searching unit that searches another available external device when the use-allowed information indicates that the user is not allowed to use the external device;
an input unit that receives input of change information from the user on whether to request the other external device to perform the process; and
a changing unit that changes destination of the request to the other external device when the input unit receives input of the change information.

5. The information processing apparatus according to claim 1, wherein
the authorization information is in a structured language format, and
the user interface controlling unit includes:
an analyzing unit that analyzes the data in the structured language format; and
a data processing unit that processes result of analysis obtained by the analyzing unit according to a predetermined rule and causes a screen of the user interface to be displayed on a displaying unit.

6. The information processing apparatus according to claim 1, wherein
the authorization information is a list of commands allowed to be executed on the external device, and
the process requesting unit requests the external device to perform the process by transmitting to the external device a command selected from the list based on the setting accepted from the user interface.

7. A processing apparatus that performs a process requested from an information processing apparatus, the processing apparatus comprising:
an authentication unit that performs an authentication process by using authentication information received from the information processing apparatus; and
an authorization information transmitting unit that returns, to the information processing apparatus, authorization information indicating a function allowed for the transmission source of the authentication information to use from among functions of the processing apparatus when the authenticating unit determines that the authentication information is valid.

8. The processing apparatus according to claim 7, wherein
the authentication information transmitting unit returns, to the information processing apparatus, the authorization information as data in a structured language format.

9. The processing apparatus according to claim 7, wherein
the authentication information transmitting unit returns, to the information processing apparatus, the authorization information as a list of commands allowed for the transmission source of the authentication information to execute.

10. A computer program product that causes a computer to execute:
outputting a request to request an external device to perform a process;
controlling a user interface so as to receive setting data required for execution of the process at the external device;
transmitting authentication information required for performing an authentication process at the external device to the external device, wherein transmission of the authentication information to the external device is performed before the controlling activates the user interface; and
receiving authorization information from the external device in response to the authentication information, wherein
the controlling includes referring to the authorization information and activating the user interface so that the user interface receives setting data required for realizing a function allowed for use from among functions of the external device.

11. A computer-readable recording medium having recorded thereon the computer program product according to claim 10.
